(19) United States
(12) Patent Application Publication
(10) Pub. No.: US 2017/0041838 A1
(43) Pub. Date: Feb. 9, 2017

(54) COMMUNICATION SYSTEM, BASE STATION DEVICE, AND METHOD

(71) Applicant: FUJITSU LIMITED, Kawasaki-shi (JP)

(72) Inventor: Izuru SATO, Chiyoda (JP)

(21) Appl. No.: 15/224,247

(22) Filed: Jul. 29, 2016

(30) Foreign Application Priority Data
Aug. 5, 2015 (JP) 2015-154687

(51) Int. Cl. H04W 36/00; H04W 40/22; H04L 12/46

(52) U.S. Cl. CPC H04W 36/0055; H04L 12/4641; H04W 40/22

(57) ABSTRACT

A communication system includes a relay device configured to relay data between a terminal device and a network through at least one of a first base station device, a second base station device and a third base station device, the first base station device and the second base station device being included in a first network group, and the third base station device being included in a second network group, and a control device configured to control the relay device, wherein the second base station device is configured to transmit, to the relay device, information for setting a path of the data when the terminal device executes a handover from the first base station device to the second base station device, and transmit, to the control device, the information when the terminal device executes the handover from the third base station device to the second base station device.

### CROSS-REFERENCE TO RELATED APPLICATION

This application is based upon and claims the benefit of priority of the prior Japanese Patent Application No. 2015-154687, filed on Aug. 5, 2015, the entire contents of which are incorporated herein by reference.

### FIELD

The present embodiments discussed herein are related to a communication system, a base station device and a method.

BACKGROUND

Presently, the 3rd Generation Partnership Project (3GPP) serving as a standardization body studies the specifications of the Long Term Evolution (LTE) system and the LTE-Advanced (LTE-A) system based on the LTE system. Regarding the LTE, LTE Release 8 to Release 12 are developed as international specifications. In addition, LTE Release 10 and international specifications subsequent thereto are called LTE-Advanced and are also called 4th generation mobile communication (4G).

In a communication system such as the LTE, a U-Plane and a control plane (C-Plane) are separated and used in some cases. The U-Plane has a function of, for example, transmitting user data between a terminal and an external network (hereinafter, called a Packet Data Network (PDN) in some cases). In addition, the C-Plane has a function of, for example, setting and controlling the U-Plane and so forth. By, for example, instructing a Serving Gateway (SGW) or instructing, via the SGW, a Packet Data Network Gateway (PGW) to set the U-Plane, a Mobility Management Entity (MME) sets the U-Plane between a terminal device and the PGW.

On the other hand, in some cases, by using handover, the terminal device changes a base station device coupled thereto. In, for example, the chapter “5.5.1.1.2” of 3GPP TS 23.401, an X2-based Handover without Serving GW relocation procedure is illustrated. In the relevant procedure, in a case where coupling of the terminal device is switched from a source eNB serving as a handover source to a target eNB serving as a handover destination, the MME transmits a “Modify Bearer Request” to the SGW or the like. In response to this, the SGW performs switching or the like of a bearer from the base station device serving as a handover source to the base station device serving as a handover destination. From this, even if, for example, a base station device to which the terminal device is coupled changes due to the handover, connectivity from the terminal device to the PGW is secured. In addition, the SGW transmits, to the MME, a response to the relevant Request. By receiving such a response, the MME is able to understand that the relevant bearer is switched.

Note that the bearer is, for example, a logical line through which the user data is transmitted. In a line in which the bearer is set, a specific level of, for example, quality of service (QoS) is secured.

In this way, while being able to understand the state of the bearer, the MME exchanges control signals such as a “Modify Bearer Request” with the target eNB, the SGW, and so forth every time the terminal device switches coupling to a base station device. In this case, if the number of terminal devices that each switch coupling to the base station device is greater than or equal to a first threshold value, the number of control signals exchanged with the target eNB, the SGW, and so forth by the MME becomes greater than or equal to a second threshold value, and a load on the MME become a problem.

As a technology related to such a communication system, there is, for example, the following technology. In other words, there is known a technology in which a concentrate constituent element is provided between the MME and an eNB or HeNB and the concentrate constituent element creates and transmits, to the MME, for example, a locally unique identifier of a mobile device, thereby causing the concentrate constituent element to operate as an MME. According to this technology, for example, it is thought that the number of connections with the eNB or HeNB simultaneously supportable in the MME is able to be decreased and the maintenance of complicated routing in the MME is able to be reduced.

As examples of the related art, there are known Japanese National Publication of International Patent Application No. 2011-525785, Japanese National Publication of International Patent Application No. 2011-526137, Japanese National Publication of International Patent Application No. 2011-526457, “General Packet Radio Service (GPRS) enhancements for Evolved Universal Terrestrial Radio Access Network (E-UTRAN) access”, 3GPP TS 23.401 V13.3.0 (2015-06), “3GPP Evolved Packet System (EPS); Evolved General Packet Radio Service (GPRS) Tunneling Protocol for Control plane (GTPv2-C); Stage 3”, 3GPP TS 29.274 V13.20 (2015-06), “Evolved Universal Terrestrial Radio Access (E-UTRA) and Evolved Universal Terrestrial Radio Access Network (E-UTRAN); Overall description; Stage 2”, 3GPP TS 36.300 V12.5.0 (2015-03) and, “Evolved Universal Terrestrial Radio Access Network (E-UTRAN); S1 Application Protocol (S1 AP)”, 3GPP TS 36.413 V13.0.0 (2015-06).

### SUMMARY

According to an aspect of the invention, a communication system includes a first base station, a second base station, a third base station, a relay device configured to relay data between a terminal device and a network through at least one of the first base station device, the second base station device and the third base station device, the first base station device and the second base station device being included in a first network group, and the third base station device being included in a second network group different from the first network group, and a control device configured to control the relay device, wherein when the terminal device executes a handover from the third base station device to the second base station device, the second base station device transmits, to the control device, information for setting a path between the second base station device and the relay device, and the control device controls the relay device to execute the process of setting the path, and when the terminal device executes the handover from the first base station device to the second base station device, the second base station device transmits, to the relay device, the information for setting the path, and the relay device executes a process of setting the path.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a configuration of a communication system.

FIG. 2 illustrates an example of the configuration of the communication system.

FIG. 3 illustrates an example of the configuration of the communication system.

FIG. 4A illustrates an example of a configuration of a terminal device.

FIG. 4B illustrates an example of a configuration of a base station device.

FIG. 5A illustrates an example of a configuration of an MME.

FIG. 5B illustrates an example of a configuration of an SGW.

FIG. 6 illustrates an example of a configuration of a PGW.

FIG. 7 is a sequence diagram illustrating an example of an operation.

FIG. 8 is a flowchart illustrating an example of an operation.

FIG. 9A illustrates an example of a correspondence relationship between a VLAN ID and an eNB ID.

FIG. 9B illustrates an example of UE context information.

FIG. 10A illustrates an example of a configuration of a GTP-U packet.

FIG. 10B illustrates an example of a configuration of a GTP-C packet.

FIG. 11 illustrates an example of switching a route.

FIG. 12 illustrates an example in which a control signal is transmitted in the communication system.

FIG. 13 is a sequence diagram illustrating an example of an operation.

FIG. 14 is a sequence diagram illustrating an example of an operation.

FIG. 15 illustrates an example in which a terminal is handed over in the communication system.

FIG. 16A illustrates an example of a hardware configuration of the terminal device.

FIG. 16B illustrates an example of a hardware configuration of the base station device.

FIG. 17A illustrates an example of a hardware configuration of the MME.

FIG. 17B illustrates an example of a hardware configuration of the SGW.

FIG. 17C illustrates an example of a hardware configuration of the PGW.

### DESCRIPTION OF EMBODIMENT(S)

By performing control other than that based on the MME, a processing load on the MME is reduced. As that technology, a concentrate constituent element, provided separately from the MME, is caused to operate as an MME.

In this way, in the technology for causing the concentrate constituent element to operate as the MME, the concentrate constituent element turns out to be newly added to a communication system, and the total cost of the communication system is increased.

Therefore, one disclosure is to provide a communication system and a coupling method, which each reduce a processing load on an MME.

In addition, one disclosure is to provide a communication system and a coupling method, which each suppress an increase in cost.

Hereinafter, embodiments for implementing the present technology will be described. Note that the following examples do not limit the disclosed technology. In addition, the individual embodiments may be arbitrarily combined insofar as contents of processing operations do not contradict one another.

### First Embodiment

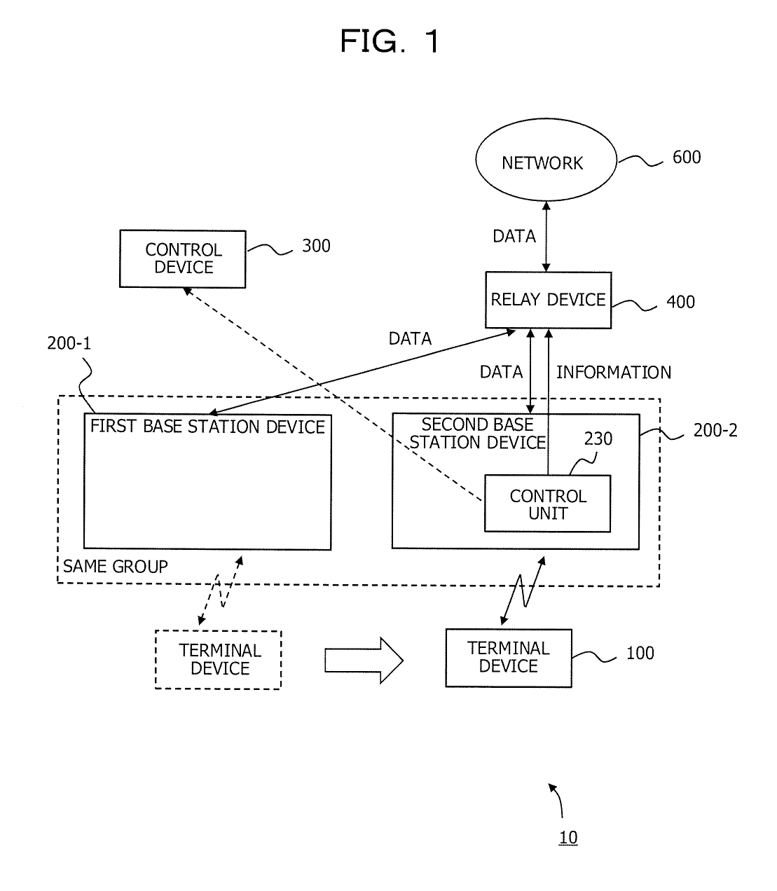

A first embodiment will be described. FIG. 1 illustrates an example of a configuration of a communication system 10 in the first embodiment. As illustrated in FIG. 1, the communication system 10 includes a terminal device 100, first and second base station devices 200-1 and 200-2, a control device 300, a relay device 400, and a network 600. In addition, the communication system 10 may include a control device 300.

The terminal device 100 is a movable communication device such as a feature phone, a smartphone, a personal computer, a tablet terminal, or a game device. In the example of FIG. 1, the terminal device 100 switches coupling from the first base station device 200-1 to the second base station device 200-2 and transmits or receives user data (or data: hereinafter called “data” in some cases) to or from the relay device 400 via the second base station device 200-2.

Each of the first and second base station devices 200-1 and 200-2 is, for example, a communication device that exchanges data with the relay device 400 and that exchanges wireless signals with the terminal device 100. The first and second base station devices 200-1 and 200-2 each serve as an interface for exchanging data and wireless signals.

The control device 300 controls the first and second base station devices 200-1 and 200-2 and the relay device 400.

The relay device 400 relays data between the first and second base station devices 200-1 and 200-2 and the network 600.

In the present first embodiment, the second base station device 200-2 includes a control unit 230. In a case where the terminal device 100 switches coupling from the first base station device 200-1 belonging to the same group to the second base station device 200-2, the control unit 230 transmits information for setting a new path to the relay device 400.

From this, no information for setting a new path is input to, for example, the control device 300 by the second base station device 200-2, and compared with a case where the relevant information is input, the number of pieces of information input to the control device 300 is decreased. Therefore, in the present communication system 10, compared with a case where the relevant information is input to the control device 300, a processing load on the control device 300 is reduced.

In addition, in the present communication system 10, no devices are separately provided between the control device 300 and the second base station device 200-2 and between the control device 300 and the first base station device 200-1. Accordingly, in the present communication system 10, compared with a case of separately providing a device, an increase in the total cost of the communication system 10 is suppressed.

### Second Embodiment

Next, a second embodiment will be described.

<Example of Configuration of Communication Network System>

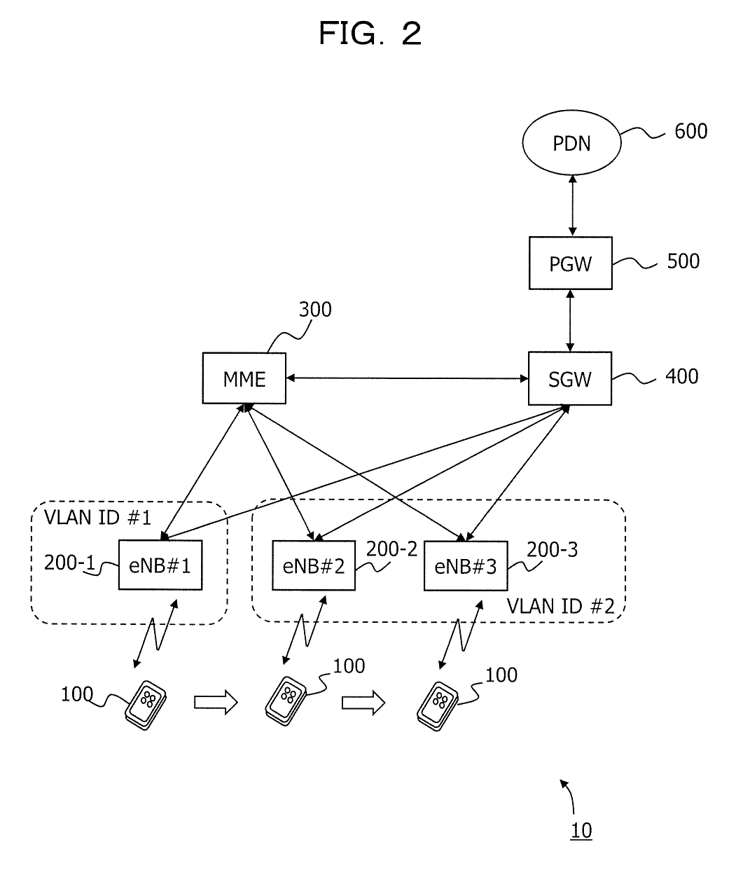

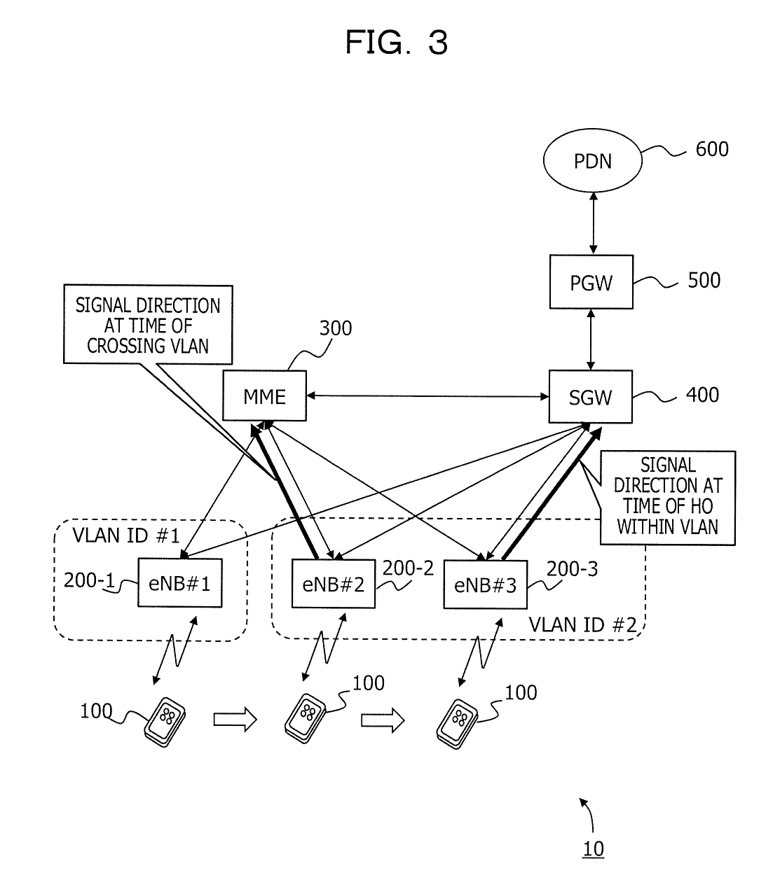

FIGS. 2 and 3 each illustrate an example of the configuration of the communication system 10 in the present second embodiment. The communication system 10 includes the terminal device (hereinafter, called a “terminal” in some cases) 100 and base station devices (“eNBs” in FIG. 2: hereinafter, called “base stations” in some cases) 200-1 to 200-3, and an MME 300. In addition, the communication system 10 includes an SGW 400 and a PGW 500.

Note that the MME 300 corresponds to, for example, the control device 300 in the first embodiment. In addition, the SGW 400 corresponds to, for example, the relay device 400 in the first embodiment.

In the communication system 10, in the same way as the LTE, the U-Plane and the C-Plane are separated and used. As described above, the U-Plane has a function of transmitting user data between the terminal 100 and a PDN 600. In addition, the C-Plane has a function of performing a setting, control, and so forth of the U-Plane. Data transmitted in, for example, the U-Plane is called “user data”, and a signal transmitted in, for example, the C-Plane is called a “control signal”, in some cases.

The terminal 100 is a movable communication device such as, for example, a feature phone, a smartphone, a tablet terminal, a personal computer, or a game device. By performing wireless communication with the base stations 200-1 to 200-3, the terminal 100 is able to receive, via the base stations 200-1 to 200-3, various provided services such as a call service and a Web service.

Each of the base stations 200-1 to 200-3 is, for example, a communication device that performs wireless communication with the terminal 100 located within the communicatable range of the station itself. Each of the base stations 200-1 to 200-3 serves as an interface that reciprocally converts wireless signals between data and so forth. Each of the base stations 200-1 to 200-3 exchanges control signals with, for example, the MME 300 and exchanges user data with, for example, the SGW 400.

The MME 300 establishes and releases a bearers from the terminal 100 to the PGW 500 and performs location management, movement control such as handover, and so forth of the terminal 100. By exchanging control signals with, for example, the individual base stations 200-1 to 200-3 and the SGW 400 and exchanging control signals with, for example, the PGW 500 via the SGW 400, the MME 300 is able to cause a bearer between the terminal 100 and the PGW 500, bearers between the SGW 400 and the respective base stations 200-1 to 200-3, and so forth to be established. By causing the bearers to be established, the MME 300 is able to set the U-Plane for the terminal 100. Note that, by using the C-Plane, the MME 300 exchanges control signals with the individual base stations 200-1 to 200-3 and the SGW 400.

The SGW 400 is, for example, a relay device (or a gateway device) that relays user data and so forth between the base stations 200-1 to 200-3 and the PGW 500. In addition, the SGW 400 exchanges control signals with the MME 300.

The PGW 500 is a relay device (or a gateway device) that couples, for example, the PDN 600 and the communication system 10 to each other and that relays user data and so forth between the PDN 600 and the communication system 10. In addition, the PGW 500 delivers an IP address to, for example, the terminal 100 and performs collecting of charging data, QoS control, and so forth.

The PDN 600 is an example of an external network coupled to the communication system 10. The PDN 600 is, for example, the Internet or the like, and a server device, which distributes moving images and music, and so forth are coupled thereto. The PDN 600 corresponds to, for example, the network 600 in the first embodiment.

FIG. 2 illustrates an example in which the terminal 100 switches coupling from the base station 200-1 to the base station 200-2 and further switches coupling from the base station 200-2 to the base station 200-3. That the terminal 100 switches the coupled base stations 200-1 to 200-3 in this way is called, for example, “handover” in some cases. By using the handover, the terminal 100 is able to receive continuously provided services.

In addition, in the example of FIG. 2, as a virtual local area network identification (VLAN ID), an “ID#1” is set in the base station 200-1, and as the VLAN ID, an “ID#2” is set in the base stations 200-2 and 200-3.

FIG. 3 illustrates examples of directions in which signals and so forth are transmitted in the communication system 10 in FIG. 2. As illustrated in FIG. 3, in the present second embodiment, in a case where handover is performed between the two base stations 200-2 and 200-3 belonging to the same VLAN ID, the base station 200-3 serving as a handover destination transmits, without transmitting, to the MME 300, information for setting a new path, the relevant information to the SGW 400. From this, compared with, for example, a case where the base station 200-3 transmits the relevant information to the MME 300, the number of pieces of information input to the MME 300 is decreased in the present communication system 10, and a processing load on the MME 300 is reduced. In addition, in the present communication system 10, an increase in the total cost of the communication system 10 is suppressed while no particular new constituent element is added.

Note that in a case where the terminal 100 is handed over between the two base stations 200-1 and 200-2, which do not belong to the same VLAN ID, the base station 200-2 serving as a handover destination transmits the relevant information to the MME 300.

In what follows, the information for setting a new path is explained as, for example, an example of a control signal in some cases.

The VLAN ID groups together, for example, one or more of the base stations 200-1 to 200-3. In addition, the VLAN ID defines a set of base stations on which handover is able to be performed without transmitting a control signal to, for example, the MME 300. Such grouping based on the VLAN ID may be set based on, for example, the movement characteristic of the terminal 100, the subscriber information of a user who uses the terminal 100, or the like. Base on, for example, the history information of handover of the terminal 100, the base stations 200-2 and 200-3 may be grouped together as one VLAN ID.

Note that, in addition to the VLAN ID, any ID may be adopted if the ID is identification information for collecting, for example, one or more of the base stations 200-1 to 200-3. As such identification information, an ID may be used that identifies, for example, a tracking area (TA) for grouping together the base stations 200-2 and 200-3 as a range in which a location registration signal does not have to be transmitted to a base station even if the terminal 100 is handed over.

Hereafter, examples of respective configurations of the terminal 100, the base stations 200-1 to 200-3, and so forth included in the communication system 10 will be described. In this regard, however, since having the same configuration, each of the base stations 200-1 to 200-3 will be described as a base station 200 unless otherwise noted.

<Example of Configuration of Terminal>

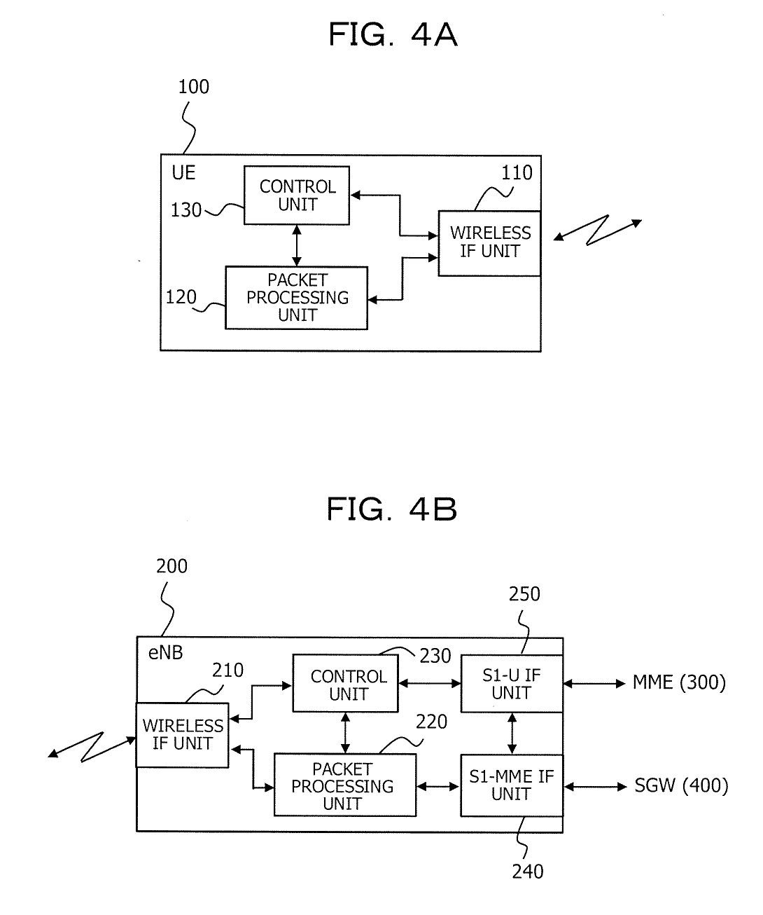

FIG. 4A illustrates an example of the configuration of the terminal (a “UE” in the drawing) 100. The terminal 100 includes a wireless interface (IF) unit 110, a packet processing unit 120, and a control unit 130.

The wireless IF unit 110 receives a wireless signal transmitted by the base station 200 and performs demodulation processing and so forth on the received wireless signal, thereby extracting user data, a control signal, and so forth. In this case, the extracted user data is, for example, packetized packet data (hereinafter, called “packets” in some cases). The wireless IF unit 110 outputs the extracted packets and the extracted control signal to the packet processing unit 120 and the control unit 130, respectively. In addition, the wireless IF unit 110 receives a control signal output by the control unit 130 and packets output by the packet processing unit 120 and performs modulation processing on the control signal, the packets, and so forth, thereby converting the control signal, the packets, and so forth into a wireless signal. The wireless IF unit 110 transmits the converted wireless signal to the base station 200.

In accordance with control based on the control unit 130, the packet processing unit 120 performs various kinds of signal processing on the packets output by the wireless IF unit 110, thereby extracting character data, an audio signal, and so forth. In accordance with control based on the control unit 130, the packet processing unit 120 outputs the extracted character data and audio signal and so forth to a monitor screen, a speaker, and so forth in the terminal 100. In addition, in accordance with control based on the control unit 130, the packet processing unit 120 receives an audio signal and so forth from a microphone and so forth and performs signal processing and so forth on these, thereby converting these into user data, and the packet processing unit 120 generates packets including the converted user data and outputs the generated packets to the wireless IF unit 110.

The control unit 130 controls the wireless IF unit 110 and the packet processing unit 120. Based on, for example, allocation information of wireless resources, included in a control signal received from the wireless IF unit 110, the control unit 130 performs processing such as instructing the wireless IF unit 110 to extract packets addressed to the station itself.

<Example of Configuration of Base Station>

FIG. 4B illustrates an example of a configuration of the base station 200. The base station 200 includes a wireless IF unit 210, a packet transfer processing unit 220, a control unit 230, an S1-U IF unit 240, and an S1-MME IF unit 250.

The wireless IF unit 210 receives a wireless signal transmitted by the terminal 100 and performs demodulation processing and so forth on the received wireless signal, thereby extracting packets, a control signal, and so forth. The wireless IF unit 210 outputs the extracted control signal and so forth to the control unit 230 and outputs the extracted packets to the packet transfer processing unit 220. In addition, the wireless IF unit 210 receives packets output by the packet transfer processing unit 220 and a control signal output by the control unit 230 and performs modulation processing and so forth on these, thereby converting these into a wireless signal. The wireless IF unit 210 transmits the converted wireless signal to the terminal 100.

In accordance with control based on, for example, the control unit 230, the packet transfer processing unit 220 transfers, to the S1-U IF unit 240, packets output by the wireless IF unit 210 and transfers, to the wireless IF unit 210, packets received from the S1-U IF unit 240.

The control unit 230 controls the wireless IF unit 210, the packet transfer processing unit 220, and the S1-MME IF unit 250. The control unit 230 generates and outputs, to the wireless IF unit 210, a control signal including, for example, allocation information of wireless resource, and so forth and generates and transmits, to the S1-MME IF unit 250, a control signal including a switching request for a path, and so forth.

The S1-U IF unit 240 exchanges user data and so forth with the SGW 400. The base station 200 and the SGW 400 are coupled to each other via, for example, an S1-U interface. In this case, the S1-U IF unit 240 performs, for example, the following processing. In other words, by using packets based on a General Packet Radio Service (GPRS) Tunneling Protocol (GTP protocol), the S1-U IF unit 240 exchanges the user data. The S1-U IF unit 240 exchanges, with the SGW 400, GTP for User plane (GTP-U) packets and GTP version 2 for User plane (GTPv2-U) packets, placed on, for example, a User Datagram Protocol/Internet Protocol (UDP/IP) protocol. Therefore, the S1-U IF unit 240 generates GTP-U packets, GTPv2-U packets, and so forth (hereinafter, called “GTP-U packets” in some cases) including (or obtained by encapsulating packets) packets output by the packet transfer processing unit 220 and transmits the generated GTP-U packets to the SGW 400. In addition, the S1-U IF unit 240 extracts, from GTP-U packets received from the SGW 400, encapsulated packets including user data and outputs the extracted packets to the packet transfer processing unit 220.

The S1-MME IF unit 250 exchanges a control signal and so forth with the MME 300. The base station 200 and the MME 300 are coupled to each other via, for example, an S1-MME interface. In this case, the S1-MME IF unit 250 performs, for example, the following processing. In other words, by using packets (hereinafter, called “S1AP packets” in some cases), placed on a Stream Control Transmission Protocol/Internet Protocol (SCTP/IP) and based on an S1AP protocol, the S1-MME IF unit 250 exchanges a control signal and so forth. Therefore, the S1-MME IF unit 250 generate S1AP packets including a control signal output by the control unit 230 and transmits the generated S1AP packets to the MME 300. In addition, the S1-MME IF unit 250 receives S1AP packets transmitted by the MME 300, extracts a control signal and so forth included in the received S1AP packets, and outputs the extracted control signal to the control unit 230.

<Example of Configuration of MME>

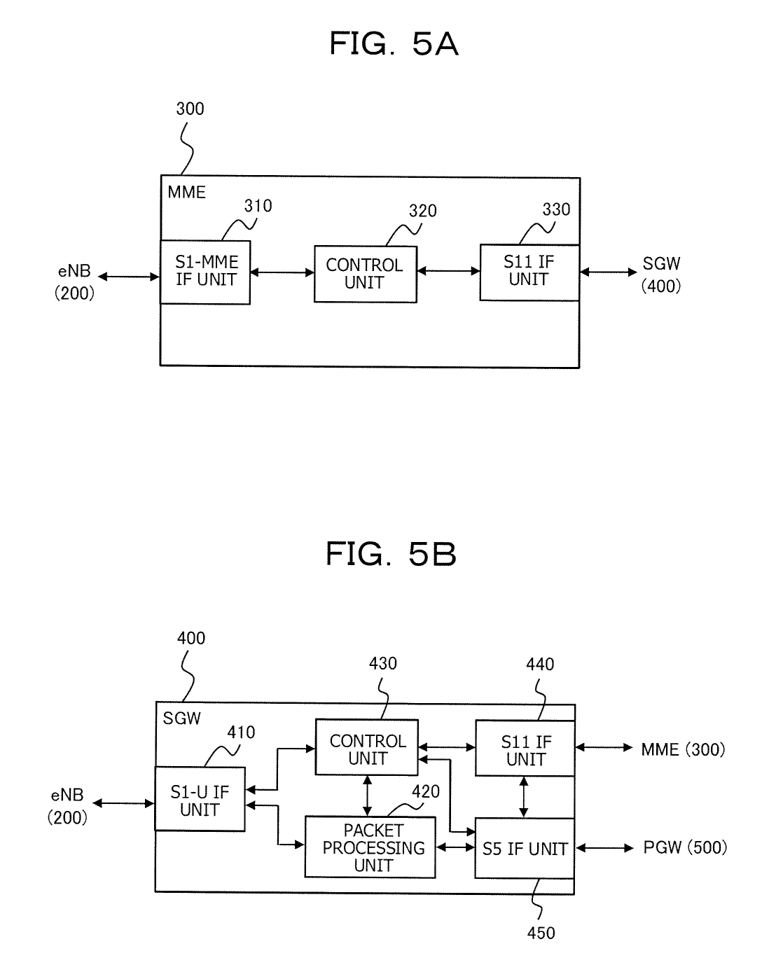

FIG. 5A illustrates an example of a configuration of the MME 300. The MME 300 includes an S1-MME IF unit 310, a control unit 320, and an S11 IF unit 330.

The S1-MME IF unit 310 exchanges a control signal and so forth with the base station 200. The S1-MME IF unit 310 performs, for example, the following processing. In other words, the S1-MME IF unit 310 receives S1AP packets transmitted by the base station 200 and extracts and outputs a control signal and so forth from the received S1AP packets and to the control unit 320. In addition, with respect to a control signal and so forth, output by the control unit 320, the S1-MME IF unit 310 generates S1AP packets including the relevant control signal and transmits the generated S1AP packets to the base station 200.

The control unit 320 controls the S1-MME IF unit 310 and the S11 IF unit 330. The control unit 320 instructs, for example, the S1-MME IF unit 310 and the S11 IF unit 330 to perform transmission, reception, and so forth of control signals. The control unit 320 arbitrarily generates control signals, exchanges a control signal with the S1-MME IF unit 310, thereby controlling the base station 200, and exchanges a control signal with the S11 IF unit 330, thereby controlling the SGW 400.

The S11 IF unit 330 exchanges a control signal with the SGW 400. The MME 300 and the SGW 400 are coupled to each other via, for example, an S11 interface and exchange control signals with each other by using packets based on the GTP protocol. In this case, the S11 IF unit 330 performs, for example, the following processing. In other words, upon receiving a control signal from the control unit 320, the S11 IF unit 330 generates GTP for Control plane (GTP-C) packets or GTPv2-C packets (hereinafter, called “GTP-C packets” in some cases) including the relevant control signal and transmits the GTP-C packets to the SGW 400. In addition, the S11 IF unit 330 extracts a control signal from GTP-C packets received from the SGW 400 and outputs the extracted control signal to the control unit 320.

By exchanging such a control signal with the base station 200 and the SGW 400, the MME 300 instructs the base station 200 and the SGW 400 to establish and release, for example, bearers.

<Example of Configuration of SGW>

FIG. 5B illustrates an example of a configuration of the SGW 400. The SGW 400 includes an S1-U IF unit 410, a packet transfer processing unit 420, a control unit 430, an S11 IF unit 440, and an S5 IF unit 450.

The S1-U IF unit 410 exchanges user data and so forth with the base station 200. The S1-U IF unit 410 performs, for example, the following processing. In other words, in accordance with control based on the control unit 430, the S1-U IF unit 410 extracts, from GTP-U packets transmitted by the base station 200, packets including user data and outputs the extracted packets to the packet transfer processing unit 420. In addition, in accordance with control based on the control unit 430, with respect to packets, which include user data and which are output by the packet transfer processing unit 420, the S1-U IF unit 410 generates GTP-U packets including the relevant packets and transmits the generated GTP-U packets to the base station 200.

In accordance with an instruction from the control unit 430, the packet transfer processing unit 420 transfers, to the S5 IF unit 450, packets output by the S1-U IF unit 410 and transfers, to the S1-U IF unit 410, packets output by the S5 IF unit 450.

The control unit 430 controls the S1-U IF unit 410, the packet transfer processing unit 420, the S11 IF unit 440, and the S5 IF unit 450. The control unit 430 instructs, for example, the S1-U IF unit 410, the packet transfer processing unit 420, and the S5 IF unit 450 to perform transmission, reception, transferring, and so forth of packets and exchanges a control signal with the MME 300. Therefore, the control unit 430 may arbitrarily generate a control signal and may exchange the control signal with the MME 300.

The S11 IF unit 440 exchanges a control signal and so forth with the MME 300. The S11 IF unit 440 performs, for example, the following processing. In other words, the S11 IF unit 440 extracts a control signal and so forth from GTP-C packets transmitted by the MME 300 and outputs the extracted control signal and so forth to the control unit 430. In addition, the S11 IF unit 440 receives a control signal and so forth from the control unit 430, generates GTP-C packets including the received control signal and so forth, and transmits the generated GTP-C packets to the MME 300.

The S5 IF unit 450 exchanges user data, a control signal, and so forth with the PGW 500. The SGW 400 is coupled to the PGW 500 via, for example, an S5 interface and exchanges GTP-U packets, GTP-C packets, and so forth with the PGW 500. The S5 IF unit 450 performs, for example, the following processing. In other words, with respect to packets output by the packet transfer processing unit 420, the S5 IF unit 450 generates GTP-U packets including (or encapsulating) the relevant packets and transmits the generated GTP-U packets to the PGW 500. In addition, upon receiving GTP-U packets transmitted by the PGW 500, the S5 IF unit 450 extracts, from the received GTP-U packets, packets including user data and so forth and outputs the extracted packets to the packet transfer processing unit 420. Furthermore, the S5 IF unit 450 receives, from the control unit 430, a control signal generated by the control unit 430, generates GTP-C packets including the control signal, and transmits the generated GTP-C packets to the PGW 500. Furthermore, the S5 IF unit 450 receives GTP-C packets transmitted by the PGW 500 and extracts and outputs a control signal and so forth from the received GTP-C packets and to the control unit 430.

By exchanging GTP-U packets with, for example, the base station 200 and the PGW 500, the SGW 400 functions as a relay device that relays user data

<Example of Configuration of PGW>

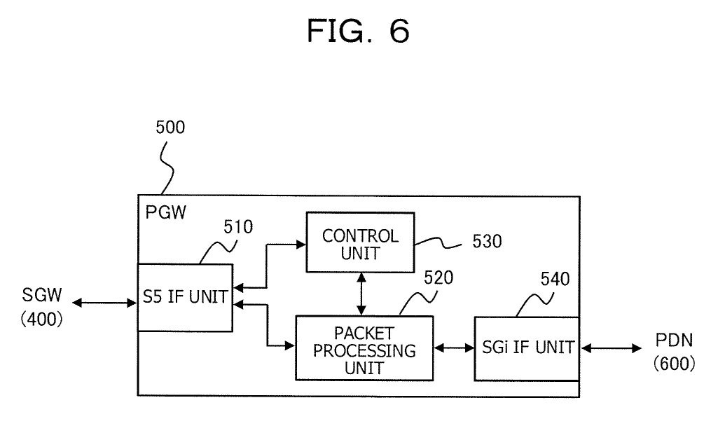

FIG. 6 illustrates an example of a configuration of the PGW 500. The PGW 500 includes an S5 IF unit 510, a packet transfer processing unit 520, a control unit 530, and an SGi IF unit 540.

The S5 IF unit 510 exchanges user data, a control signal, and so forth with the SGW 400. The S5 IF unit 510 performs, for example, the following processing. In other words, the S5 IF unit 510 receives a control signal from the control unit 530 and generates and transmits, to the SGW 400, GTP-C packets including the relevant control signal. In addition, upon receiving, from the packet transfer processing unit 520, packets including user data, the S5 IF unit 510 generates and transmits, to the SGW 400, GTP-U packets including (or encapsulating) the relevant packets. Furthermore, upon receiving GTP-C packets from the SGW 400, the S5 IF unit 510 extracts and outputs a control signal and so forth from the relevant packets and to the control unit 530. Furthermore, upon receiving GTP-U packets from the SGW 400, the S5 IF unit 510 extracts and outputs packets including user data from the relevant packets and to the packet transfer processing unit 520.

The packet transfer processing unit 520 transfers, to the SGi IF unit 540, the packets output by the S5 IF unit 510 and transfers, to the S5 IF unit 510, packets output by the SGi IF unit 540.

The control unit 530 controls the S5 IF unit 510, the packet transfer processing unit 520, and so forth. The control unit 530 may exchange a control signal with the SGW 400, and the control unit 530 generates a control signal and instructs the S5 IF unit 510 to transmit the generated control signal. The control unit 530 may deliver an IP address to, for example, the terminal 100 and may generate and transmit, to the SGW 400, a control signal, which includes this IP address, and so forth.

In accordance with control based on the control unit 530, the packet transfer processing unit 520 transfers, to the SGi IF unit 540, packets output by the S5 IF unit 510 and transfers, to the S5 IF unit 510, packets output by the SGi IF unit 540.

The SGi IF unit 540 exchanges user data and so forth with the PDN 600. The SGi IF unit 540 converts the packets transferred by the packet transfer processing unit 520 into, for example, packets based on a format transmittable to the PDN 600 and transmits the packets to the PDN 600. In addition, the SGi IF unit 540 receives packets transmitted by the PDN 600, extracts, from the received packets, packets to be transmitted to the terminal 100, and outputs the extracted packets to the packet transfer processing unit 520.

<Example of Operation>

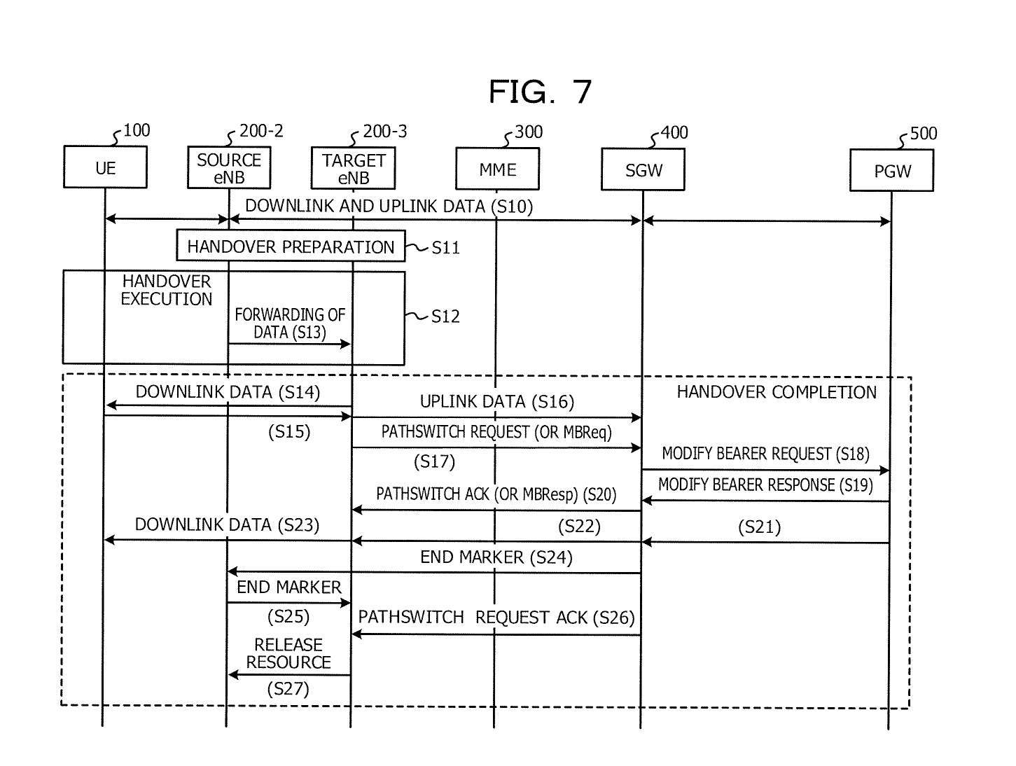

Next, an example of an operation will be described. FIG. 7 is a sequence diagram illustrating an example of an operation. FIG. 7 illustrates an example of a sequence of handover procedures in the communication system 10. The example of FIG. 7 illustrates an example in which the terminal 100 is handed over from the base station (a “Source eNB” in FIG. 7: hereinafter, called a “source base station” in some cases) 200-2 to the base station (a “Target eNB”: hereinafter, called a “target base station” in some cases) 200-3. The source base station 200-2 is a base station serving as a handover source, and the target base station 200-3 is a base station serving as a handover destination.

In the present second embodiment, as illustrated in FIG. 3 and so forth, it is assumed that the source base station 200-2 and the target base station 200-3 belongs to the same VLAN ID.

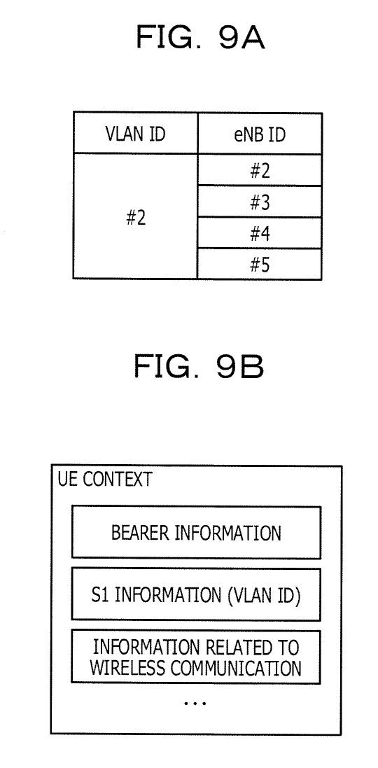

FIG. 9A illustrates an example of a correspondence relationship between a VLAN ID and an eNB ID. FIG. 9A illustrates an example of a VLAN ID held by the target base station 200-3. The example illustrated in FIG. 9A indicates that the base stations 200 having “#2” to “#5” as the pieces of identification information of the respective base stations 200 belong to “#2” serving as the same VLAN ID. For example, the two base stations 200-2 (“#2”) and 200-3 (“#3”) belong to the same VLAN ID of “#2”. Note that the target base station 200-3 may hold the VLAN ID (“#2”) assigned to the station itself while not holding the pieces of identification information (“#3” to “#5”) of the other base stations. Note that the VLAN IDs may be held in an internal memory or the like in the control unit 230 in each of the base stations 200. Regarding assigning the VLAN ID to each of the base stations 200, the VLAN ID may be assigned by an operator at the time of installing the corresponding base station, and the VLAN ID may be assigned by exchanging a control signal with another base station after initiating the operation of the corresponding base station 200.

First, by using FIG. 7, an example of an operation of the entire communication system 10 will be described. Individual processing operations (S10 to S27) illustrated in FIG. 7 are performed in, for example, the control units 130, 230, 320, 430, 530, and so forth in the individual devices 100, 200-2, 200-3, 300, 400, and 500.

<Example of Operation of Entire Communication System>

As illustrated in FIG. 7, the terminal 100 and the PGW 500 exchange user data with each other via the source base station 200-2 and the SGW 400 (S10).

Note that the direction of a communication link headed from the PGW 500 to the terminal 100 is called a downlink direction (or “Downlink”), and the direction of a communication link headed from the terminal 100 to the PGW 500 is an uplink direction (or “Uplink”) in some cases.

Next, a preparation for handover (“preparation”) is performed in the two base stations 200-2 and 200-3 (S11). Each of the two base stations 200-2 and 200-3 is put into, for example, a state of performing preliminarily defined handover procedures.

Next, execution procedures of handover (“Handover execution”) are executed between the terminal 100 and the base stations 200-2 and 200-3 (S12). For example, the following processing is performed. In other words, the terminal 100 measures communication qualities of respective wireless sections of the source base station 200-2 and the target base station 200-3 and transmits the communication qualities to the source base station 200-2. Based on the communication qualities, the source base station 200-2 determines that the terminal 100 is handed over from the base station 200-2 to the base station 200-3. In the handover execution procedures, the source base station 200-2 may transmit, to the MME 300, a handover request signal serving as a control signal requesting that the terminal 100 is handed over to the base station 200-3, and in response to this, the MME 300 may transmit a control signal instructing the target base station 200-3 to execute handover. The target base station 200-3 may notify the terminal 100 that a base station to serve as a handover destination is the station itself.

In the handover execution procedures, the source base station 200-2 forwards (or transfers), to the target base station 200-3, user data in the downlink direction, difficult to transmit to the terminal 100 (S13).

If a series of handover execution procedures (S12) finish, the target base station 200-3 transmits the forwarded user data to the terminal 100 (S14).

In addition, the terminal 100 transmits user data in the uplink direction to the target base station 200-3 serving as a handover destination (S15). The target base station 200-3 transmits, to the SGW 400, the user data in the uplink direction (S16).

Next, the target base station 200-3 transmits a “Pathswitch request” to the SGW 400 (S17). The “Pathswitch request” is, for example, a control signal and is a path switching signal requesting to switch a path. In this case, the “Pathswitch request” is a control signal requesting to switch a path in the downlink direction between the SGW 400 and the source base station 200-2 to a path in the downlink direction between the SGW 400 and the target base station 200-3.

The target base station 200-3 transmits the “Pathswitch request” to the MME 300 in some cases. In this case, for example, the following processing is performed. In other words, upon receiving the “Pathswitch request”, the MME 300 transmits a control signal instructing the SGW 400 to set a path in the downlink direction between the SGW 400 and the target base station 200-3. In response to this, the SGW 400 sets a path in the downlink direction (or an S1 bearer in the downlink direction) with the target base station 200-3.

In the present second embodiment, the target base station 200-3 does not transmit the “Pathswitch request” to the MME 300, but transmits the “Pathswitch request” to the SGW 400. In this case, under assumption of receiving an instruction to switch a path, transmitted by, for example, the MME 300, the SGW 400 sets a path in the downlink direction for the target base station 200-3.

In a normal situation, the “Pathswitch request” is a control signal transmitted to the MME 300 by the base station 200, and in this case, the “Pathswitch request” is transmitted while being included in an S1AP packet. Accordingly, in a case where the target base station 200 transmits the “Pathswitch request” to the MME 300, the “Pathswitch request” may be transmitted as an S1AP packet.

In this case, for example, the following processing is performed. In other words, after instructing the packet transfer processing unit 220 and so forth to transmit packets including user data in the uplink direction, the control unit 230 in the target base station 200-3 generates the “Pathswitch request”. The control unit 230 outputs the generated “Pathswitch request” to the S1-MME IF unit 250 and instructs the S1-MME IF unit 250 to generate an S1AP packet including the “Pathswitch request”. The S1-MME IF unit 250 generates the S1AP packet including the “Pathswitch request” and outputs the generated S1AP packet to the S1-U IF unit 240. The S1-U IF unit 240 transmits the received S1AP packet to the SGW 400. In addition, upon receiving an S1AP packet (S20 or S26), which includes a response signal corresponding to the “Pathswitch request” and which is transmitted by the SGW 400, the S1-U IF unit 240 outputs the S1AP packet to the S1-MME IF unit 250, and the S1-MME IF unit 250 extracts and outputs the response signal from the S1AP packet and to the control unit 230.

On the other hand, in the SGW 400, for example, the following processing is performed. In other words, upon receiving the S1AP packet including the “Pathswitch request”, the S1-U IF unit 410 in the SGW 400 extracts the “Pathswitch request” from the S1AP packet and outputs the extracted “Pathswitch request” to the control unit 430. In addition, upon receiving the “Pathswitch request”, the control unit 430 generates a response signal at an adequate timing and instructs the S1-U IF unit 410 to generate and transmit an S1AP packet including the response signal. In response to this, the S1-U IF unit 410 transmits the S1AP packet including the response signal.

In this way, the target base station 200-3 and the SGW 400 only have to be set so as to process the S1AP packet including the “Pathswitch request”.

While, in the above-mentioned example, an example of the “Pathswitch request” utilizing the S1AP packet is described, a “Modify Bearer Request” (“MBReq”) transmittable as a GTP-C packet may be used. In this case, the target base station 200 transmits the “Modify Bearer Request” in place of the “Pathswitch request”. The “Modify Bearer Request” is, for example, a control signal and is a bearer modification signal requesting to modify a quality between the target base station 200-3 and the SGW 400.

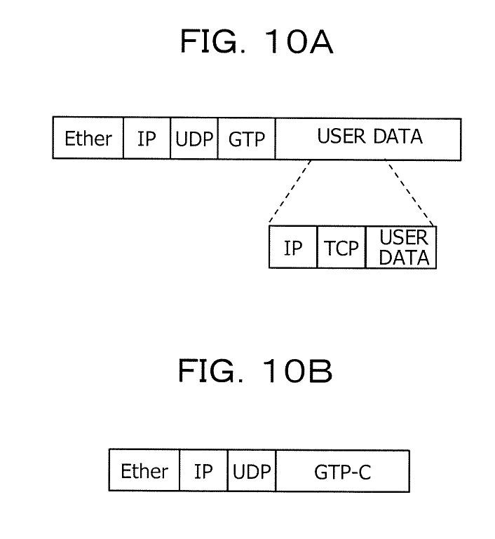

FIG. 10A illustrates an example of a configuration of a GTP-U packet. FIG. 10A illustrates an example of a GTP-U packet transmitted or received between the base stations 200-2 and 200-3 and the SGW 400. In the GTP-U packet, a GTP header is included in a “GTP” area, and one or more Internet Protocol (IP) packets are included in a “data” area. User data is included in the IP packets.

FIG. 10B illustrates an example of a configuration of a GTP-C packet. A control signal expressing, for example, the “Modify Bearer Request” is included in a “GTP-C” area of the GTP-C packet.

In this case, in the target base station 200-3, for example, the following processing is performed. In other words, after instructing the packet transfer processing unit 220 and so forth to transmit packets including user data in the uplink direction, the control unit 230 in the target base station 200-3 generates the “Modify Bearer Request”. The control unit 230 outputs the generated “Modify Bearer Request” to the S1-U IF unit 240 via the packet transfer processing unit 220. In addition, the control unit 230 outputs, to the S1-U IF unit 240 via the packet transfer processing unit 220, a control signal instructing the S1-U IF unit 240 to generate a GTP-C packet including the “Modify Bearer Request”. In this case, the control unit 230 may directly output the “Modify Bearer Request” to the S1-U IF unit 240 and may directly output a control signal instructing to generate a GTP-C packet. In response to this, the S1-U IF unit 240 generates and transmits, to the SGW 400, a GTP-C packet including the “Modify Bearer Request”. In addition, the S1-U IF unit 240 receives a GTP-C packet including a response signal corresponding to the “Modify Bearer Request”, extracts the response signal from the received GTP-C packet, and outputs the relevant control signal to the control unit 230 via the packet transfer processing unit 220. The S1-U IF unit 240 may directly output the extracted response signal to the control unit 230.

On the other hand, in the SGW 400, for example, the following processing is performed. Upon receiving the GTP-C packet including the “Modify Bearer Request”, the S1-U IF unit 410 extracts and outputs the “Modify Bearer Request” from the GTP-C packet and to the control unit 430. Upon receiving the “Modify Bearer Request”, the control unit 430 generates, at an adequate timing, a response signal corresponding to the “Modify Bearer Request” and instructs the S1-U IF unit 410 to generate and transmit an GTP-C packet including the response signal, and in response to this, the S1-U IF unit 410 generates and transmits, to the target base station 200-3, the GTP-C packet including the response signal.

In this way, the target base station 200-3 and the SGW 400 only have to be set so as to process the GTP-C packet including the “Modify Bearer Request”.

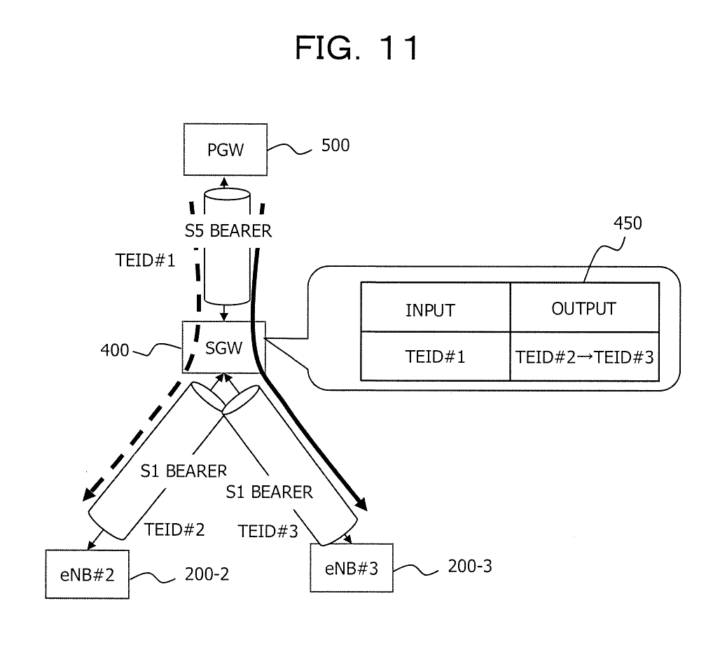

FIG. 11 illustrates an example of switching a route. FIG. 11 illustrates an example in which the SGW 400 that receives the “Pathswitch request” switches a path. In the example of FIG. 11, the SGW 400 sets an S1 bearer in the downlink direction with the source base station 200-2 and sets a tunnel endpoint identifier (TEID) thereof to “#2”. In addition, an S5 bearer is set between the SGW 400 and the PGW 500, and the TEID is set to “#1”. The SGW 400 includes a routing table 450. In the routing table 450, the TEID, “#1”, of the S5 bearer is stored as an “input”, and the TEID, “#2”, of the S1 bearer with the source base station 200-2 is stored as an “output”. The routing table 450 is stored in, for example, an internal memory or the like in the control unit 430.

In such a case, upon receiving the “Pathswitch request” from the target base station 200-3, the SGW 400 changes to the TEID, “#3”, serving as an S1 bearer to the target base station 200-3, with respect to the “output” in the routing table 450. The TEID, “#3”, in the downlink direction between the SGW 400 and the target base station 200-3 is generated by, for example, the target base station 200-3 and transmitted while being included in the “Pathswitch request”.

Upon receiving, based on a change in the routing table 450 from the PGW 500, packets including user data addressed to the terminal 100, the SGW 400 transmits the relevant packets to the target base station 200-3. Such a change is performed by, for example, the control unit 430.

Regarding the above-mentioned “Modify Bearer Request”, such switching of a path as illustrated in FIG. 11 may be performed. The two control signals of the “Pathswitch request” and the “Modify Bearer Request” may be control signals having the same function in switching of a path, performed by the SGW 400.

Returning to FIG. 7, upon receiving the “Pathswitch request” (S17), the SGW 400 transmits the “Modify bearer request” to the PGW 500 (S19). From this, the PGW 500 is notified of such switching of a path as illustrated in, for example, FIG. 11.

Upon receiving the “Modify bearer request”, the PGW 500 transmits a “Modify bearer response” to the SGW 400 (S19). Note that S18 or S19 may be omitted.

Next, the SGW 400 transmits a “Pathswitch ack” (or the “Modify Bearer Response”) to the target base station 200-3 (S20). As described above, the “Pathswitch ack” is a response signal corresponding to the “Pathswitch request” and may be transmitted while being included in an S1AP packet. In addition, as described above, the “Modify Bearer Response” is a response signal corresponding to the “Modify Bearer Request” and may be transmitted while being included in a GTP-C packet.

In addition, user data in the downlink direction is transmitted to the terminal 100 by the PGW 500 via the SGW 400 and the target base station 200-3 (S21 to S23).

Next, the SGW 400 transmits an “End marker” to the source base station 200-2 (S24). Upon receiving the “End marker”, the source base station 200-2 transmits the “End marker” to the target base station 200-3 (S25). From this, for example, user data, addressed to the terminal 100 and retained in the source base station 200-2 and the target base station 200-3, is transmitted to the terminal 100.

Next, the SGW 400 transmits a “Pathswitch request ack” to the target base station 200-3 (S26). The “Pathswitch request ack” is a response signal indicating, for example, that the “Pathswitch request” (S17) is normally received. Note that, for example, the “Pathswitch ack” (FIG. 20) may be used as a substitute for the “Pathswitch request ack” and in that case the “Pathswitch request ack” (S26) may be omitted. In the same way as the “Pathswitch ack”, the “Pathswitch request ack” may be transmitted while being included in an S1AP packet, and in the same way as the “Modify Bearer Response”, the “Pathswitch request ack” may be transmitted while being included in a GTP-C packet.

Next, the target base station 200-3 transmits a “Release resource” to the source base station 200-2 (S27). Upon receiving the “Release resource”, the source base station 200-2 releases, for example, wireless resources and so forth for the terminal 100.

In FIG. 7, an example in which the target base station 200-3 transmits the “Pathswitch request” to the SGW 400 (S17) is described. The target base station 200-3 may transmit, to the SGW 400, for example, a path release signal (for example, a “Pathrelease request”) requesting to release a set path without transmitting the path release signal to the MME 300. The path release signal includes information related to a path to serve as a release target. Such information may be the TEID, “#3”, illustrated in, for example, FIG. 11. The SGW 400 that receives this signal releases the S1 bearer of the TEID, “#3”, set in the example of, for example, FIG. 11 and deletes the TEID, “#3”, from the routing table 450. The path release signal is, for example, an example of a control signal transmitted to the SGW 400 without being transmitted to the MME 300. The path release signal may be transmitted while being included in an S1AP packet and may be transmitted while being included in a GTP-C packet.

<Example of Operation of Target Base Station>

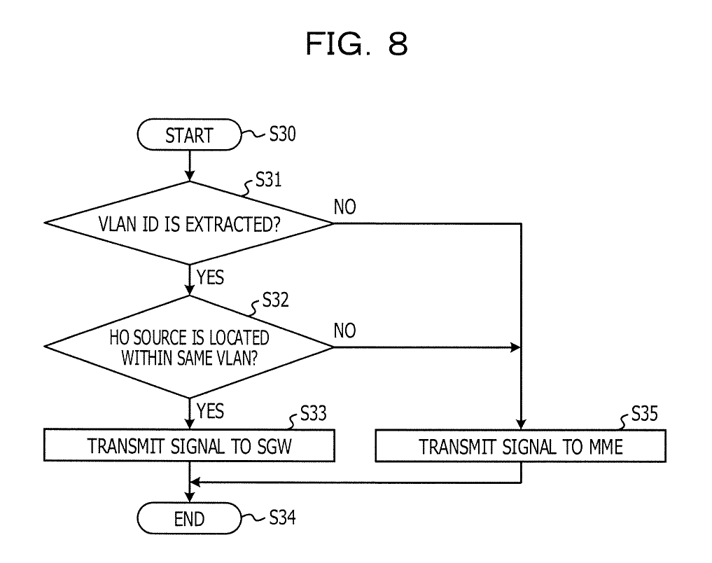

Next, an example of an operation in the target base station 200-3 will be described. FIG. 8 is a flowchart illustrating an example of an operation in the target base station 200-3. Individual processing operations illustrated in FIG. 8 are performed in, for example, the control unit 230 in the target base station 200-3.

To perform handover processing (for example, S12 in FIG. 7), the target base station 200-3 may start the present processing (S30).

Next, the target base station 200-3 confirms whether or not the VLAN ID is extracted (S31).

At the time of executing a handover procedure with, for example, the source base station 200-2, the target base station 200-3 receives, from the source base station 200-2, UE context information related to the terminal 100.

FIG. 9B illustrates an example of the UE context information. The UE context information includes bearer information, S1 information, information related to wireless communication, and so forth. The bearer information includes, for example, information related to a bearer set between the terminal 100 and the PGW 500 (for example, the ID of a Evolved Packet System (EPS) bearer, or the like). In addition, the S1 information includes the IP address of the MME 300, a terminal identifier, and so forth.

In the present second embodiment, the S1 information of the UE context information includes, for example, the VLAN ID of the source base station 200-2. The target base station 200-3 extracts the VLAN ID of the source base station 200-2 from the UE context information received from the source base station 200-2. In addition, as illustrated in, for example, FIG. 9A, the target base station 200-3 holds, in an internal memory or the like, a table indicating one of the VLAN IDs, to which the station itself belongs, and by extracting the corresponding VLAN ID from the table, the target base station 200-3 is able to extract the VLAN ID of the station itself.

Accordingly, in a case where the target base station 200-3 extracts the VLAN ID of the source base station 200-2 from, for example, the UE context information and is able to extract, from the internal memory, the corresponding VLAN ID assigned to the station itself (S31: YES), the processing makes a transition to S32.

On the other hand, in a case where no VLAN ID is set in the source base station 200-2 and it is difficult to extract the VLAN ID of the source base station 200-2 from the UE context information (S31: NO), the target base station 200-3 makes a transition to S35. In addition, in a case where no VLAN ID is set in the target base station 200-3 itself and it is difficult to extract, from a memory such as the internal memory, the corresponding VLAN ID assigned to the target base station 200-3 itself (S31: NO), the target base station 200-3 makes a transition to S35.

Note that the target base station 200-3 serves as a source base station and becomes a base station serving as a handover source of the terminal 100 in some cases. In this case, the base station 200-3 generates and transmits the UE context information to the base station 200-3 to serve as a target base station. The control unit 230 in the target base station 200-3 reads, from, for example, the internal memory, the VLAN ID assigned to the station itself, causes the corresponding VLAN ID to be included in the UE context information, and transmits the corresponding VLAN ID to a base station serving as a handover destination.

In a case of extracting the VLAN ID (S31: YES), the target base station 200-3 determines whether or not the VLAN ID of the source base station 200-2 serving as a handover source and the VLAN ID of the target base station 200-3 itself are identical to each other (S32).

In a case where the VLAN ID of the source base station 200-2 and the VLAN ID of the target base station 200-3 itself are identical to each other (S32: YES), the target base station 200-3 transmits a control signal to the SGW 400 (S33). In this case, since the source base station 200-2 and the target base station 200-3 belong to the same VLAN ID, the target base station 200-3 transmits the control signal to the MME 300 without transmitting the control signal to the SGW 400.

On the other hand, in a case where the VLAN ID of the source base station 200-2 and the VLAN ID of the target base station 200-3 itself do not coincide with each other (S32: NO), the target base station 200-3 transmits a control signal to the MME 300 (S35). This is a case where the VLAN IDs do not coincide with each other in the two base stations 200-2 and 200-3, an in this case, the target base station 200-3 transmits the control signal to the MME 300.

In a case of transmitting the control signal (S33 or S35), the target base station 200-3 terminates a series of processing operations (S34).

In this way, in the present second embodiment, the base stations 200-2 and 200-3 that each transmit a control signal not to the MME 300 but to the SGW 400 are put together into one group as the VLAN ID. It is possible to extend the range of this group throughout, for example, Japan. However, there is a case of searching for a specific base station 200, such as a case of identifying one of the base stations 200, to which a terminal that does not yet pay a charge is coupled, there is a case where the number of the base stations 200 included in one VLAN ID is larger than a fifth threshold value, and there is a case where it takes time to search. Accordingly, in consideration of searching for the base station 200, and so forth, the number of the base stations 200 included in one VLAN ID may be less than or equal to the fifth threshold value.

Note that since the MME 300 does not receive the “Pathswitch request” in the present second embodiment, it is difficult to understand whether the terminal 100 is accurately coupled to, for example, the target base station 200-3 after handover. Therefore, by using multicast, the MME 300 may transmit a control signal to all base stations 200 having the same VLAN ID as that of the target base station 200-3. From this, in a case where the MME 300 transmits a control signal to, for example, the target base station 200-3, a control signal is transmitted to the target base station 200-3 to which the terminal 100 is coupled.

<Regarding TEID>

The target base station 200-3 after handover sets an S1 bearer with the SGW 400 and assigns the TEID to the set S1 bearer in some cases. In addition, in some cases, the target base station 200-3 transmits the assigned TEID to the MME 300 while causing the assigned TEID to be included in the “Pathswitch request”.

However, in the present second embodiment, the target base station 200-3 transmits no “Pathswitch request” to the MME 300. Accordingly, it is difficult for the MME 300 to understand the S1 bearer newly set by the target base station 200-3 and the TEID thereof.

Therefore, in the present second embodiment, by using an EPS bearer ID included in a control signal transmitted to the MME 300 by the SGW 400, the MME 300 is caused to perform processing on a newly set S1 bearer.

An EPS bearer is a bearer (or a path) set between, for example, the terminal 100 and the PGW 500, and even if the terminal 100 changes, based on handover, coupling of the corresponding base station 200, the EPS bearer ID (or the path identification information of a path between the terminal 100 and the PGW 500) is not changed. Accordingly, even if the MME 300 does not know that the new S1 bearer is set between the target base station 200-3 and the SGW 400, the MME 300 becomes able to cause user data to be transmitted to the relevant S1 bearer and to cause the relevant S1 bearer to be released, by using the EPS bearer ID.

In this case, the target base station 200-3 and the SGW 400 only have to hold a correspondence relationship between the EPS bearer ID and the TEID of the S1 bearer. The target base station 200-3 and the SGW 400, which each receive, from the MME 300, a control signal specifying the EPS bearer ID, are able to perform processing on the newly set S1 bearer, based on the correspondence relationship. The control unit 230 in the target base station 200-3 and the control unit 430 in the SGW 400 each hold the correspondence relationship between the EPS bearer ID and the TEID in, for example, an internal memory or the like.

The target base station 200-3 holds the correspondence relationship in, for example, the following way. In other words, in the handover execution procedures (S12), the control unit 230 receives the UE context information from the source base station 200-2, and the UE context information includes the EPS bearer ID. In addition, based on the VLAN ID included in the UE context information, the control unit 230 transmits the “Pathswitch request” to the SGW 400 (for example, S33 in FIG. 8), and at this time, the control unit 230 sets a new S1 bearer for the SGW 400 (for example, FIG. 11). Accordingly, based on the EPS bearer ID included in the UE context information referenced at the time of transmitting the “Pathswitch request” to the SGW 400 and the S1 bearer newly set at this time, the control unit 230 holds the correspondence relationship between the EPS bearer and the TEID.

In addition, the SGW 400 holds the correspondence relationship in, for example, the following way. In other words, the control unit 430 extracts, from the “Pathswitch request”, the TEID assigned by the target base station 200-3 and modifies the routing table 450 (for example, FIG. 11). The routing table includes, for example, the EPS bearer ID assigned by the MME 300. The control unit 430 only has to read the TEID changed in the routing table 450 and the EPS bearer ID included in the routing table 450, to extract the correspondence relationship between the EPS bearer ID and the TEID of the newly set S1 bearer, and to hold the correspondence relationship in the internal memory or the like.

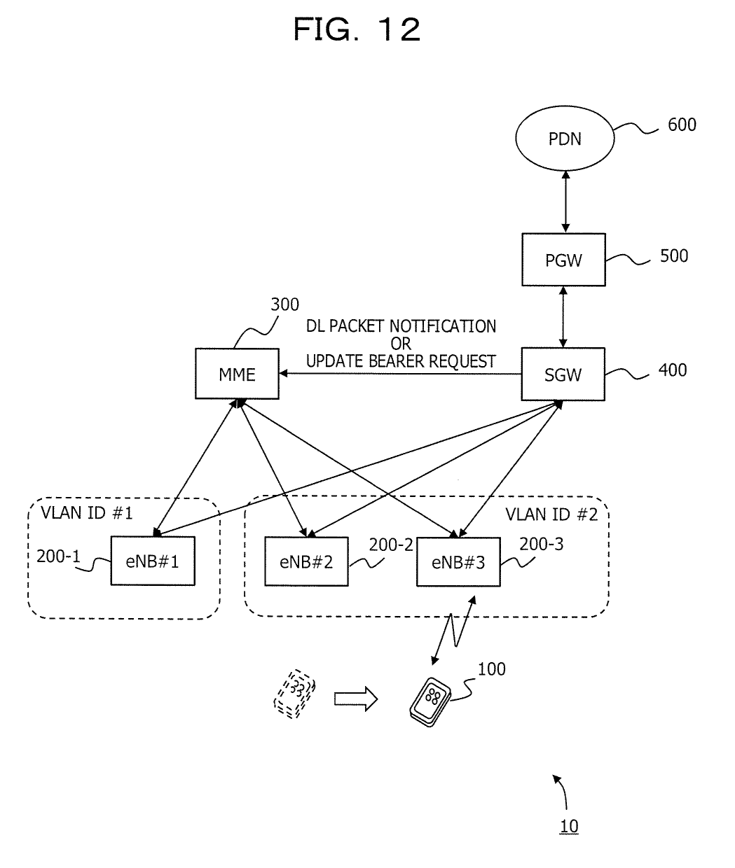

FIG. 12 is an example of a control signal transmitted to the MME 300 by the SGW 400 in the communication system 10. The relevant control signal includes the EPS bearer ID. FIG. 12 illustrates an example in which the MME 300 is notified of the EPS bearer ID.

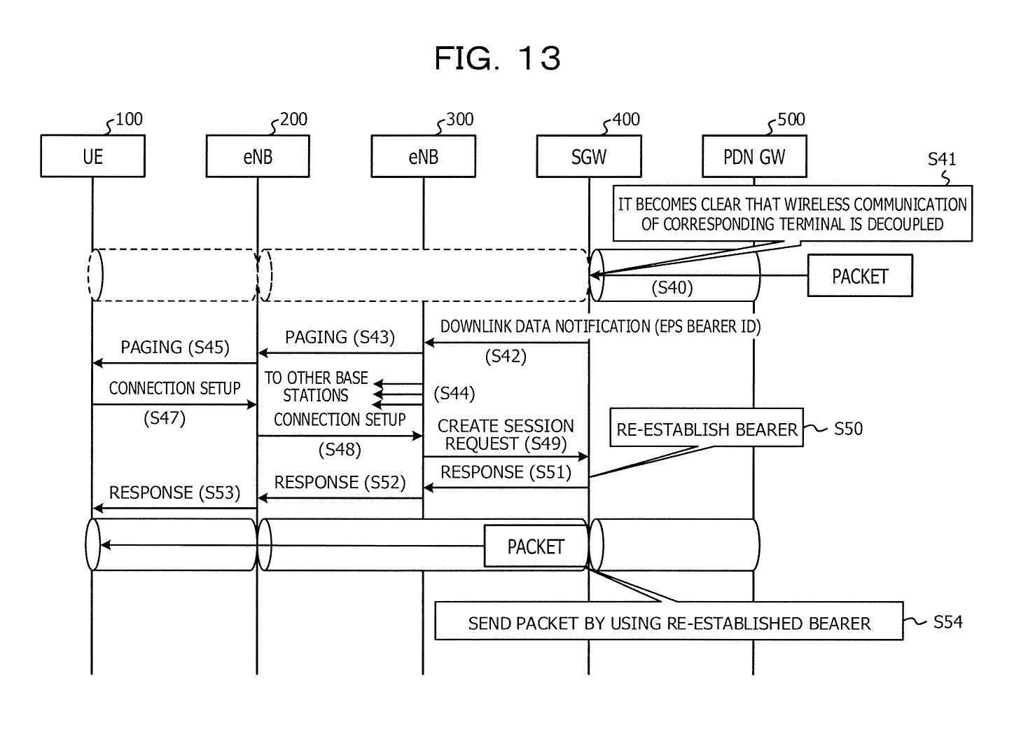

A “DL packet notification” is, for example, a control signal transmitted in a case where there is downlink data addressed to the terminal 100 when the terminal 100 is in an idle state. The “DL packet notification” is transmitted by a procedure called a Network Triggered Service Request (in, for example, FIG. 13).

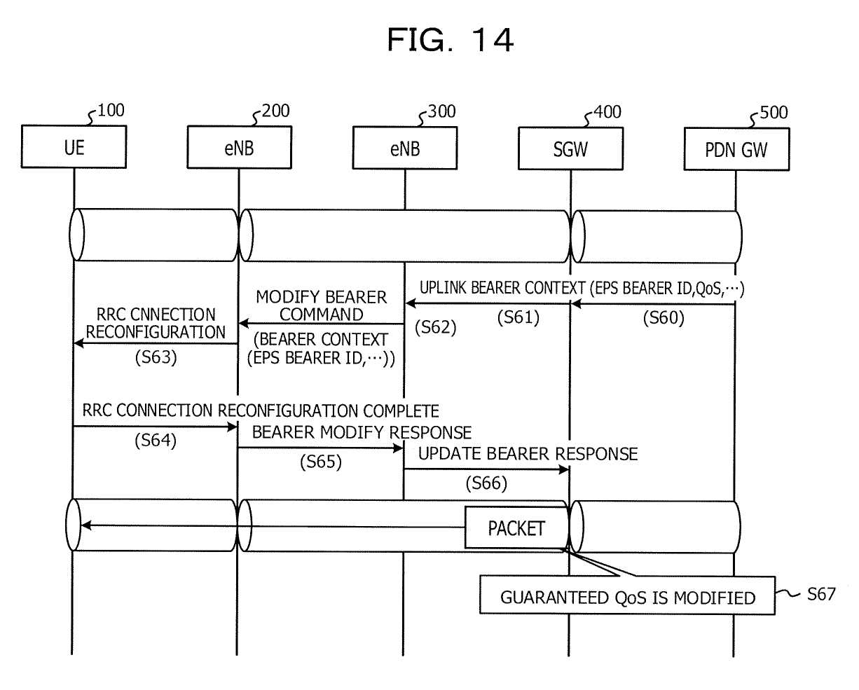

An “Update Bearer Request” is, for example, a control signal transmitted in a case where a communication quality guaranteed in a bearer is modified when the terminal 100 is in an active state. The “Update Bearer Request” is transmitted by a procedure for modifying a bearer from a network side (in, for example, FIG. 14).

FIG. 13 illustrates an example of the procedure called the Network Triggered Service Request. This procedure is executed in, for example, a case where after terminal 100 is handed over to the base station 200, the terminal 100 makes a transition to the idle state or the like and wireless communication between the terminal 100 and the base station 200 is decoupled.

Upon receiving, from the PGW 500, a packet including user data addressed to the terminal 100 (S40), the SGW 400 confirms that wireless communication with the terminal 100 is decoupled (S41).

At this time, the SGW 400 transmits, to the MME 300, the “DL packet notification” including the EPS bearer ID (S42). For example, the following processing is performed. In other words, the control unit 430 in the SGW 400 reads the EPS bearer ID held in the internal memory and generates the “DL packet notification” including the EPS bearer ID. The control unit 430 transmits the generated “DL packet notification” to the MME 300. On the other hand, upon receiving the “DL packet notification”, the control unit 320 in the MME 300 extracts the EPS bearer ID from the “DL packet notification” and holds, in the internal memory or the like, the EPS bearer ID.

After that, the MME 300 performs a procedure for putting the terminal 100 into the active state (S43 to S48). In this case, since the wireless communication with the terminal 100 is decoupled, the MME 300 transmits, for example, a “Paging” to all base stations 200 located within a tracking area (TA) (S43 and S44). Upon receiving a “Connection Setup” from the terminal 100 via the corresponding coupled base station 200, the MME 300 transmits a “Create Session Request” to the SGW 400 (S48 and S49). Upon receiving the “Create Session Request”, the SGW 400 re-establishes a bearer (S50). The SGW 400 transmits a response message to the terminal 100 (S51 to S53) and transmits, by using the re-established bearer, a packet received from the PGW 500 (S54).

FIG. 14 illustrates an example of a procedure for modifying a bearer from a network side. Upon receiving, from the PGW 500, the “Update Bearer Request” including the EPS bearer ID (S60), the SGW 400 transfers the “Update Bearer Request” to the MME 300 (S61). Upon receiving, for example, the “Update Bearer Request” from the PGW 500, the control unit 430 in the SGW 400 generates and transmits, to the MME 300, the “Update Bearer Request” including the EPS bearer ID. The control unit 320 in the MME 300 extracts the EPS bearer ID from, for example, the received “Update Bearer Request” and holds, in the internal memory or the like, the EPS bearer ID.

After that, by using the EPS bearer ID included in the “DL packet notification”, the “Update Bearer Request”, or the like, the MME 300 becomes able to perform processing on a newly set S1 bearer. Accordingly, in the present communication system 10, the MME 300 becomes able to perform processing on the newly set S1 bearer with making no modification to an existing control signal, and compared with a case of defining and using a new signal, an increase in cost is suppressed.

<Regarding Terminal Identifier in S1AP>

The base station 200 and the MME 300 are coupled to each other via, for example, an S1-MME interface. In this case, the base station 200 assigns an “eNB UE S1AP ID” to the terminal 100 in some cases. The “eNB UE S1AP ID” is, for example, an identifier (or identification information) of the terminal 100, locally used between the base station 200 and the MME 300.

By transmitting, to the MME 300, the “Pathswitch request” including, for example, the “eNB UE S1AP ID”, the base station 200 notifies the MME 300 of the “eNB UE S1AP ID” assigned by the base station 200. By using, for example, the “eNB UE S1AP ID”, the MME 300 performs transmission of a control signal to the base station 200, or the like, thereby becoming able to perform control of a session or the like on the terminal 100.

However, in the present second embodiment, the base station 200 does not transmit the “Pathswitch request” to the MME 300. Accordingly, it is difficult for the MME 300 to understand the “eNB UE S1AP ID” assigned by the target base station 200-3. Therefore, even if the “eNB UE S1AP ID” assigned by the source base station 200-2 and the “eNB UE S1AP ID” assigned by the target base station 200-3 are different from each other, it is difficult for the MME 300 to understand that the “eNB UE S1AP ID” is changed.

Therefore, in the present second embodiment, in a case where handover is performed between the base stations 200 having the same VALN ID, changing the “eNB UE S1AP ID” is avoided. From this, in, for example, a case where the MME 300 transmits a control signal to the base station 200, the correct “eNB UE S1AP ID” is specified.

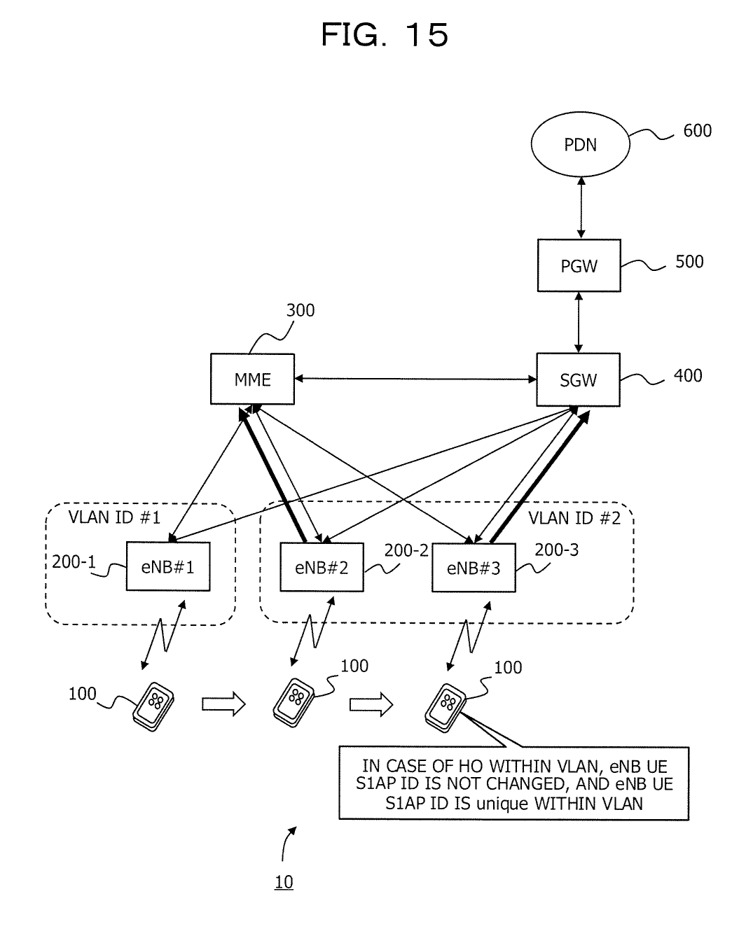

FIG. 15 illustrates an example of the communication system 10. As illustrated in FIG. 15, in a case where handover is performed within the same VLAN ID, the “eNB UE S1AP ID” is not changed, and in a case where handover is performed between different VLAN IDs, the “eNB UE S1AP ID” is changed.

In order to avoid changing the “eNB UE S1AP ID”, for example, the following processing may be performed. In other words, in a case of receiving no “eNB UE S1AP ID” from the other base stations 200-1 and 200-3, the source base station 200-2 assigns the “eNB UE S1AP ID” to the terminal 100. In addition, the source base station 200-2 transmits the assigned “eNB UE S1AP ID” to the target base station 200-3. Since receiving the “eNB UE S1AP ID” from the other base station, the target base station 200-3 avoids assigning the “eNB UE S1AP ID” in the station itself.

In this regard, however, the “eNB UE S1AP ID” assigned to one terminal 100 by the source base station 200-2 is set to a unique ID so that the “eNB UE S1AP ID” does not overlap with another terminal within the same VLAN ID. In a case where the overlapped “eNB UE S1AP ID” is assigned to a different terminal, in spite of instructing the corresponding base station 200 to control, for example, a session for a first terminal 100-1, the MME 300 turns out to control a session for a second terminal 100-2. By defining the “eNB UE S1AP ID” as the unique ID within the same VLAN ID, the MME 300 is able to avoid, for example, a situation of controlling a session for a terminal different from the terminal 100 for which control of a session is to be performed.

### Another Embodiment

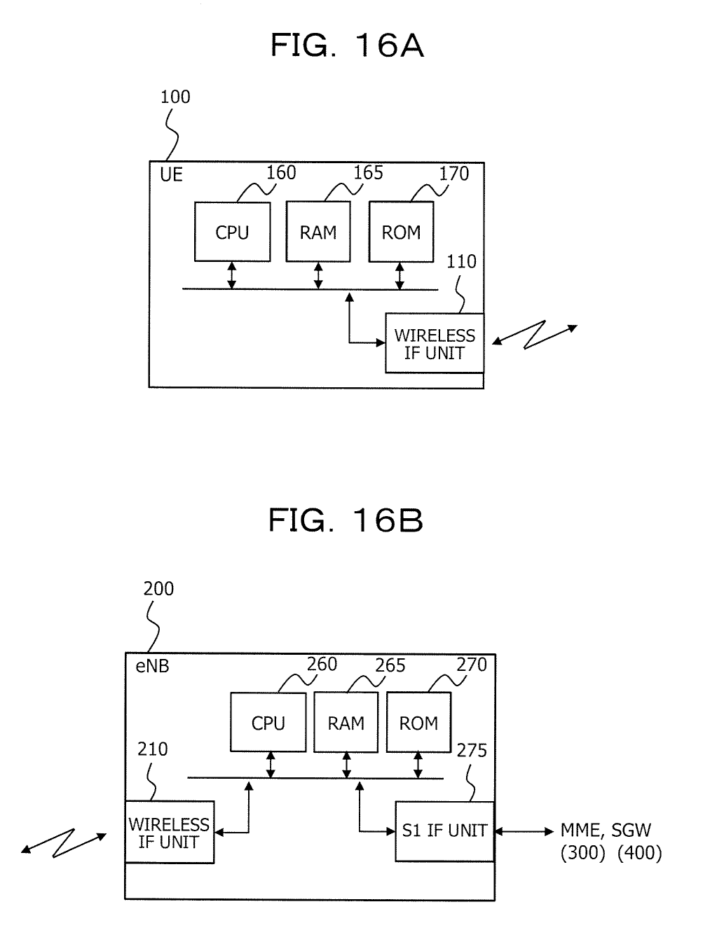

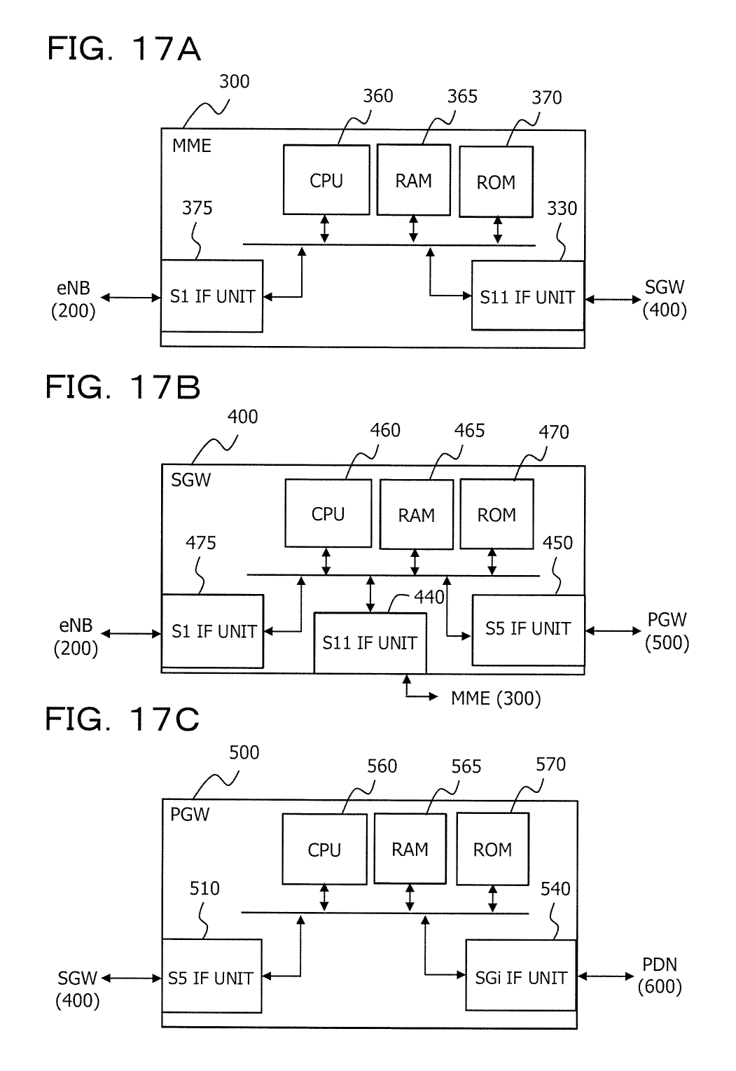

FIGS. 16A, 16B, 17A, 17B, and 17C illustrate examples of hardware configurations of respective devices in the communication system 10.

FIG. 16A illustrates an example of a hardware configuration of the terminal 100. The terminal 100 includes a central processing unit (CPU) 160, a random access memory (RAM) 165, a read only memory (ROM) 170, and a wireless IF unit 110.

The CPU 160 reads and loads, into the RAM 165, a program stored in the ROM 170 and executes the loaded program, thereby performing the functions of the control unit 130 and the packet processing unit 120. The CPU 160 corresponds to, for example, the control unit 130 and the packet processing unit 120 in the second embodiment.

FIG. 16B illustrates an example of a hardware configuration of the base station 200. The base station 200 includes a CPU 260, a RAM 265, a ROM 270, and an S1 IF unit 275.

The CPU 260 reads and loads, into the RAM 265, a program stored in the ROM 270 and executes the loaded program, thereby performing the functions of the packet transfer processing unit 220 and the control unit 230. The CPU 260 corresponds to, for example, the packet transfer processing unit 220 and the control unit 230 in the second embodiment. In addition, the S1 IF unit 275 corresponds to, for example, the S1-U IF unit 240 and the S1-MME IF unit 250 in the second embodiment. For example, the VLAN ID assigned to the base station 200, the UE context information, and so forth are stored in the RAM 265.

FIG. 17A illustrates an example of a hardware configuration of the MME 300. The MME 300 includes a S11 IF unit 330, a CPU 360, a RAM 365, a ROM 370, and an S1 IF unit 375.

The CPU 360 reads and loads, into the RAM 365, a program stored in the ROM 370 and executes the loaded program, thereby performing the function of the control unit 320. The CPU 360 corresponds to, for example, the control unit 320 in the second embodiment. In addition, the S1 IF unit 375 corresponds to, for example, the S1-MME IF unit 310 in the second embodiment.

FIG. 17B illustrates an example of a hardware configuration of the SGW 400. The SGW 400 includes an S11 IF unit 440, an S5 IF unit 450, a CPU 460, a RAM 465, a ROM 470, and an S1 IF unit 475.

The CPU 460 reads and loads a program from the ROM 470 and into the RAM 465 and executes the loaded program, thereby performing the functions of the packet transfer processing unit 420 and the control unit 430. The CPU 460 corresponds to, for example, the packet transfer processing unit 420 and the control unit 430 in the second embodiment. In addition, the S1 IF unit 475 corresponds to, for example, the S1-U IF unit 410 in the second embodiment. For example, the routing table 450 and so forth are stored in the RAM 465.

FIG. 17C illustrates an example of a hardware configuration of the PGW 500. The PGW 500 includes an S5 IF unit 510, an SGi IF unit 540, a CPU 560, a RAM 565, and a ROM 570. The CPU 560 reads and loads a program from the ROM 570 and into the RAM 565 and executes the loaded program, thereby performing the functions of the packet transfer processing unit 520 and the control unit 530. The CPU 560 corresponds to, for example, the packet transfer processing unit 520 and the control unit 530 in the second embodiment.

The functions, the processing operations, and so forth described in the second embodiment may be performed by the examples of the hardware configurations of the respective devices illustrated in, for example, FIGS. 16A, 16B, 17A, 17B, and 17C. Note that each of the CPUs 160, 260, 360, 460, and 560 may be a controller or processor such as a micro processing unit (MPU) or a field-programmable gate array (FPGA).

In the above-mentioned second embodiment, an example in which, for example, GTP-U packets based on the GTP protocol are transmitted and received between the base station 200 and the SGW 400 and between the SGW 400 and the PGW 500 is described. In place of, for example, the GTP protocol, Proxy Mobile IPv6 (PMIPv6) serving as a mobility-based protocol may be used. In this case, PMIPv6 packets including user data are transmitted and received between the base station 200 and the SGW 400 and between the SGW 400 and the PGW 500.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication system comprising:
a first base station,
a second base station,
a third base station, a relay device configured to relay data between a terminal device and a network through at least one of the first base station device, the second base station device and the third base station device, the first base station device and the second base station device being included in a first network group, and the third base station device being included in a second network group different from the first network group; and
a control device configured to control the relay device, wherein
when the terminal device executes a handover from the third base station device to the second base station device, the second base station device transmits, to the control device, information for setting a path between the second base station device and the relay device, and the control device controls the relay device to execute the process of setting the path, and
when the terminal device executes the handover from the first base station device to the second base station device, the second base station device transmits, to the relay device, the information for setting the path, and the relay device executes a process of setting the path.

2. The communication system according to claim 1, wherein
the information indicates at least one of a requesting of a path switching from a first other path between the first base station device and the relay device to the path between the second base station device and the relay device, a requesting of a path switching from a second other path between the third base station device and the relay device to the path between the second base station device and the relay device, a requesting of a bearer quality modification in the path, and a requesting of a path releasing of at least one of the first other path and the a second other path.

3. The communication system according to claim 1, wherein
the control device is configured to transmit the information to the first base station device and the second base station device.

4. The communication system according to claim 1, wherein
the control device is configured to control the path between the second base station device and the relay device by using path identification information identifying the first other path between the first base station device and the relay device transmitted by the relay device.

5. The communication system according to claim 1, wherein
the second base station device is configured to identify the terminal device, using first identification information of the terminal device assigned by the first base station device and used by the first base station device and the control device.

6. The communication system according to claim 1, wherein
the second base station device is configured to identify the terminal device using second identification information of the terminal device different from third identification information assigned by the third base station device and used by the third base station device and the control device.

7. The communication system according to claim 1, wherein
the first network group is a first Virtual Local Area Network.

8. The communication system according to claim 7, wherein
the second network group is a second Virtual Local Area Network different from the first Virtual Local Area Network.

9. The communication system according to claim 7, wherein
the relay device is a Serving Gateway, and
the control device is a Mobility Management Entity.

10. A base station device which is configured to be coupled to a relay device, the relay device being configured to relay data between a terminal device and a network through the base station device, and the relay device being configured to be controlled by a control device, the base station device comprising:
a memory; and
a processor coupled to the memory and configured to:
transmit, to the relay device, information for setting a path between the base station device and the relay device when the terminal device executes a handover from a first other base station device to the base station device, the first other base station device and the base station device being included in a first network group, and
transmit, to the control device, the information for setting the path when the terminal device executes the handover from a second other base station device to the base station device, the second other base station device being included in a second network group different from the first network group.

11. The base station device according to claim 10, wherein
the information indicates at least one of a requesting of a path switching from a first other path between the first other base station device and the relay device to the path between the base station device and the relay device, a requesting of a path switching from a second other path between the second other base station device and the relay device to the path between the base station device and the relay device, a requesting of a bearer quality modification in the path, and a requesting of a path releasing of at least one of the first other path and the a second other path.

12. The base station device according to claim 10, wherein
the control device is configured to transmit the information to the first other base station device and the base station device.

13. The base station device according to claim 10, wherein
the control device is configured to control the path between the base station device and the relay device by using path identification information identifying a first other path between the first other base station device and the relay device transmitted by the relay device.

14. The base station device according to claim 10, wherein
the processor is configured to identify the terminal device, using first identification information of the terminal device assigned by the first other base station device and used by the first other base station device and the control device.

15. The base station device according to claim 10, wherein
the processor is configured to identify the terminal device using second identification information of the terminal device different from third identification information assigned by the second other base station device and used by the second other base station device and the control device.

16. The base station device according to claim 10, wherein
the first network group is a first Virtual Local Area Network.

17. The base station device according to claim 16, wherein
the second network group is a second Virtual Local Area Network different from the first Virtual Local Area Network.

18. A method using a communication system including a relay device and a control device, the relay device being configured to relay data between a terminal device and a network through at least one of a first base station device, a second base station device and a third base station device, the control device being configured to control the relay device, the first base station device and the second base station device being included in a first network group, and the third base station device being included in a second network group different from the first network group, the method comprising:
when the terminal device executes a handover from the third base station device to the second base station device,
transmitting, from the second base station device to the control device, information for setting a path between the second base station device and the relay device, and
controlling, by the controlling device, the relay device to execute the process of setting the path; and
when the terminal device executes a handover from the first base station device to the second base station device,
transmitting, from the second base station device to the relay device, the information for setting the path, and
executing, by the relay device, a process of setting the path.

19. The method according to claim 18, wherein
the information indicates at least one of a requesting of a path switching from a first other path between the first base station device and the relay device to the path between the second base station device and the relay device, a requesting of a path switching from a second other path between the third base station device and the relay device to the path between the second base station device and the relay device, a requesting of a bearer quality modification in the path, and a requesting of a path releasing of at least one of the first other path and the a second other path.
